(19) United States
(12) Patent Application Publication
(10) Pub. No.: US 2002/0197470 A1
(43) Pub. Date: Dec. 26, 2002

(54) Adhesive sheet strips

(75) Inventor: Thorsten Krawinkel, Hamburg (DE)

Correspondence Address: KURT BRISCOE, NORRIS, MCLAUGHLIN & MARCUS, P.A., 220 EAST 42ND STREET, 30TH FLOOR, NEW YORK, NY, 10017, US

(73) Assignee: tesa Aktiengesellschaft

(21) Appl. No.: 10/076,822

(22) Filed: Feb. 15, 2002

(30) Foreign Application Priority Data
May 12, 2001 (DE) 101 23 291.8

(51) Int. Cl. B32B 7/12; B32B 15/04

(52) U.S. Cl. 428/343; 428/354

(57) ABSTRACT

An adhesive sheet strip for a bond which is redetachable without residue or destruction by extensive stretching in the bond plane, having a pressure sensitive adhesive based on styrene block copolymers, wherein the pressure sensitive adhesive comprises an acid-modified and/or acid anhydride-modified elastomer.

### INTRODUCTION/PRIOR ART

The invention relates to a pressure sensitive adhesive for single-sidedly or double-sidedly pressure-sensitively adhesive sheet strips which are redetachable without residue or destruction by extensive stretching in the bond plane, and with which neither the substrate nor the article to be bonded is damaged or discolored.

Elastically or plastically highly extensible self-adhesive tapes which can be redetached without residue or destruction by extensive stretching in the bond plane (referred to below sometimes as strippable self-adhesive tapes) are known from U.S. Pat. No. 4,024,312, DE 33 31 016, WO 92/11332, WO 92/11333, DE 42 22 849, WO 95/06691, DE 195 31 696, DE 196 26 870, DE 196 49 727, DE 196 49 728, DE 196 49 729, DE 197 08 366 and DE 197 20 145.

They are frequently employed in the form of single-sidedly or double-sidedly pressure-sensitively adhesive sheet strips (adhesive tape strips, adhesive strips), which preferably have a nonadhesive grip tab region from which the detachment process is initiated. Particular applications of self-adhesive tapes of this kind can be found in DE 42 33 872, DE 195 11 288, U.S. Pat. No. 5,507,464, U.S. Pat. No. 5,672,402 and WO 94/21157; specific embodiments are described, for example, in DE 44 28 587, DE 44 31 914, WO 97/07172, DE 196 27 400, WO 98/03601 and DE 196 49 636, DE 197 20 526, DE 197 23 177, DE 297 23 198, DE 197 26 375, DE 197 56 084, DE 197 56 816, WO 99/31193, WO 99/37729 and WO 99/63018.

Preferred fields of use of abovementioned strippable adhesive sheet strips include in particular the residuelessly and nondestructively redetachable fixing of light to moderately heavy articles in the home, workplace, and office segments. In these applications they replace conventional fastening means, such as drawing pins, roundhead needles, thumb tacks, nails, screws, conventional self-adhesive tapes, and liquid adhesives, to name but a few. Key to the successful use of the abovementioned adhesive sheet strips is not only the possibility of residueless and nondestructive redetachment of bonded articles but also their quick and easy bonding and the secure hold they provide for the envisaged period of bonding. It should be borne in mind in particular here that the adhesive strips must possess functional capacity on a large number of substrates in order to be able to act as a universal fixing in particular in the home, workplace, and office segments.

Although the patent literature cited above describes a broad range of pressure sensitive adhesives (PSAs) for use in strippable self-adhesive tapes, commercial products presently on the market (e.g., tesa® Powerstrips® from Beiersdorf AG, 3M Command® adhesive strips from 3M, and Plastofix® Formule Force 1000 adhesive strips from Plasto S. A.) all feature PSAs based on styrene block copolymers with unsaturated polydiene blocks in the elastomer block. Typically, use is made of linear or radial block copolymers based on polystyrene blocks and polybutadiene blocks and/or polyisoprene blocks, i.e., for example, radial styrene-butadiene (SB)n and/or linear styrene-butadiene-styrene (SBS) and/or linear styrene-isoprene-styrene (SIS) block copolymers. Advantages of the aforementioned styrene block copolymer based PSAs for use in strippable self-adhesive tapes include, for example, the very high bond strengths that can be achieved with them (owing, inter alia, to the simultaneous realization of very high cohesion and very high adhesive forces), a pronounced reduction in tackiness during stretch release (which greatly facilitates the detachment process or, even, without which the detachment process is impossible), and also a very high tensile strength, essential in particular for a tear-free detachment process.

A disadvantage with the prior art products, however, is the discoloration of the substrate and/or of the bonded article, especially on prolonged bonding. Substrate discoloration may appear to a particular extent if primary antioxidants based on sterically hindered phenols are used, especially if the sterically hindered phenols used contain a 3-(p-hydroxyphenyl)-propionic acid group or a 3-(o-hydroxyphenyl)propionic acid group. Antioxidants of this kind are typically used to stabilize styrene block copolymer based PSAs and/or to stabilize many of the raw materials used in such PSAs. Owing to the use of such aging inhibitors in many of the raw materials used in corresponding PSAs, which is effected by the manufacture of the raw materials, such as, for example, in many tackifier resins or in many styrene block copolymers themselves, the industrial production of adhesives which are free from such compounds is generally not possible. At the same time, moreover, it is often not desirable, since these particular aging inhibitors are highly effective antioxidants.

Examples of aforementioned primary antioxidants containing a 3-(p-hydroxyphenyl)propionic acid group or a 3-(o-hydroxyphenyl)propionic acid group are obtainable, for example, under the brand names Irganox 1010, Irganox 1035, and Irganox 1076 from Ciba Additive, Sumilizer BP 101 and Sumilizer BP 76 from Sumitomo, and Hostanox O 10 and Hostanox O 16 from Clariant, to name but a few.

### OBJECTIVE

The object was a single-sidedly or double-sidedly pressure-sensitively adhesive sheet strip for a residuelessly and nondestructively redetachable bond which can be removed from a joint by stretching substantially in the bond plane, which brings about discoloration neither on the substrate nor on the bonded article, and which is based on styrene block copolymers.

### ATTAINMENT

This object is achieved surprisingly through the use of an acid-modified and/or acid anhydride-modified elastomer, such as is obtainable in particular on the basis of SEBS and/or SEPS, e.g., under the name Kraton FG 1901 and Kraton FG 1924 from Shell, or Tuftec M from Asahi, and also Septon KL 01 M1 from Kuraray. For the use of such an elastomer it is possible to a very substantial extent to suppress the red discolorations which occur, especially on sensitive substrates, such as coated woodchip wallpaper, for example. When SEBS and/or SEPS elastomers are replaced with those with acid or acid anhydride modification, the adhesive properties of the adhesive strips remain very largely the same.

### PRESSURE SENSITIVE ADHESIVES

Pressure sensitive adhesives employed are preferably those based on block copolymers comprising polymer blocks formed by vinylaromatics (A blocks), preferably styrene, and those formed by polymerization of 1,3-dienes (D blocks), preferably butadiene and isoprene. Both homopolymer blocks and copolymer blocks can be utilized in accordance with the invention. Resultant block copolymers may contain identical or different D blocks, which may be partly, selectively or fully hydrogenated. Block copolymers may have a linear A-D-A structure. It is likewise possible to use block copolymers of radial design, and also star-shaped and linear multiblock copolymers. As further components, A-D diblock copolymers may be present. Block copolymers of vinyl aromatics and isobutylene are likewise suitable for use in accordance with the invention. All of the aforementioned polymers may be utilized alone or in a mixture with one another.

Instead of the polystyrene blocks, it is also possible to use polymer blocks based on other homopolymers and copolymers containing aromatics (preferably C-8 to C-12 aromatics) with glass transition temperatures of > about 75° C., such as aromatic blocks containing α-methylstyrene, for example. Also useful are polymer blocks based on (meth)acrylate homopolymers and (meth)acrylate copolymers having glass transition temperatures of >+75° C. In this case it is possible to use both block copolymers which use exclusively blocks based on (meth)acrylate polymers as hard blocks and those which use both polyaromatic blocks, e.g., polystyrene blocks, and poly(meth)acrylate blocks.

Instead of styrene-butadiene block copolymers and styrene-isoprene block copolymers and their hydrogenation products, including styrene-ethylene/butylene block copolymers and styrene-ethylene/propylene block copolymers, it is likewise possible in accordance with the invention to use block copolymers and their hydrogenation products which utilize further polydiene-containing elastomer blocks, such as copolymers of two or more different 1,3-dienes, for example.

Typical use concentrations for the styrene block copolymers are situated within the range between 20% by weight and 70% by weight, preferably within the range between 30% by weight and 60% by weight, with particular preference within the range between 35% by weight and 55% by weight.

As further polymers it is possible for those based on straight hydrocarbons, e.g., unsaturated polydienes, such as natural or synthesized polyisoprene or polybutadiene, elastomers which chemically are substantially saturated, such as saturated ethylene-propylene copolymers, for example, α-olefin copolymers, polyisobutylene, butyl rubber, ethylene-propylene rubber, and also chemically functionalized hydrocarbons, such as halogen-containing, acrylate-containing or vinyl ether-containing polyolefins, for example, to be present, which may replace up to about 100 phr, based on the styrene block copolymer, of the block copolymers containing vinyl aromatics.

PSAs of the invention may be crosslinked chemically, in particular by radiation-chemical means (e.g., by UV irradiation, y-irradiation, or by exposure to rapid electrons). Adhesives of the invention are optionally those whose pressure-sensitive adhesion is produced only by thermal or solvent activation.

Besides those described above based on block copolymers containing vinyl aromatics, suitable PSAs include all those which possess extension, cohesion, and tensile strengths which are sufficient for the detachment process. PSAs of this kind may be used alone or in combination with those based on block copolymers containing vinyl aromatics.

As tackifiers, PSAs of the invention utilize as their main component, in particular, tackifier resins which are compatible with the elastomer block of the styrene block copolymers. Those with preferred suitability include the following: unhydrogenated, partly hydrogenated or fully hydrogenated resins based on rosin and rosin derivatives, hydrogenated polymers of dicyclopentadiene, unhydrogenated or partly, selectively or fully hydrogenated hydrocarbon resins based on C-5, C-5/C-9 or C-9 monomer streams, polyterpene resins based on α-pinene and/or β-pinene and/or δ-limonene, hydrogenated polymers of preferably straight C-8 and C-9 aromatics. The aforementioned tackifier resins may be used either alone or in a mixture.

As further additives, use may typically be made of light stabilizers, such as UV absorbers, sterically hindered amines, antiozonants, metal deactivators, processing aids, and endblock-reinforcing resins.

Plasticizing agents, such as liquid resins, plasticizer oils or low molecular mass liquid polymers, such as low molecular mass polyisobutylenes having molar masses <1500 g/mol (number average), for example, or liquid EPDM grades, are used typically in small amounts of < about 20% by weight.

Fillers, such as silica, glass (ground or in the form of beads), aluminum oxides, zinc oxides, calcium carbonates, titanium dioxides, and carbon blacks, to name but a few, and also color pigments and dyes, and also optical brighteners, may likewise be used.

### ANTIOXIDANTS

Normally, primary and secondary antioxidants are added to styrene block copolymer based PSAs in order to improve their aging stability. Primary antioxidants react with oxy and peroxy radicals which may form in the presence of oxygen, and react with them to give less-reactive compounds. Secondary antioxidants reduce, for example, hydroperoxides to alcohols. As is known, there is a synergistic effect between primary and secondary aging inhibitors, so that the protective effect of the mixture is frequently greater than the sum of the two individual effects. Primary oxidants used as standard in PSAs based on styrene block copolymers are, very frequently, sterically hindered phenols which carry a 3-(p-hydroxyphenyl)propionic acid group or a 3-(o-hydroxyphenyl)propionic acid group, such as Irganox 1010, Irganox 1076, Irganox 259, Irganox 1035 and Irganox 1135 from Ciba Additive, Sumilizer BP 101 and Sumilizer BP 76 from Sumitomo or Hostanox O 10 and Hostanox O 16 from Clariant, Anox 20 from Eni Chem Sintesis, or Lowinox PP 35 and Lowinox PO 35 from Chemische Werke Lowi, to name but a few.

When antioxidants are used, especially those of the type mentioned above, there may be red discolorations of the substrate, especially when bonding, for example, to wallpaper or walls painted with emulsion paint or latex paint.

The aforementioned discolorations occur preferentially at the edge of the adhesive strip, pointing to the interaction with atmospheric oxygen. It may be noted that the adhesive strips themselves do not visibly discolor, but only the substrate to which they are bonded.

All of the aforementioned antioxidants comprise grades which are praised for not causing discoloration.

In order for the antioxidants or their degradation products to be able to discolor the substrate red, they must first of all diffuse from the adhesive strip into the substrate. For this reason it is understandable that the discoloration of the substrate itself depends greatly on the compatibility of the adhesives with the antioxidants and/or their degradation products and thus on the nature of the styrene block copolymers, tackifier resins, and other additives that are used.

In the case of permanent bonds, the aforementioned discolorations frequently are not disruptively manifested in practice, since they are generally not visible. Only the use of the redetachable adhesive strips reveals the discolorations in a problematic way, when more or less strongly pronounced red edges appear around the former bond area following detachment. A further decisive influencing parameter on the discoloration tendency is the duration of bonding: the longer an adhesive strip is in contact with a surface, the greater the possible discoloration of the substrate in the contact region of the bond.

For the assumed reaction with atmospheric oxygen, the antioxidants or their successive products must migrate into the substrate surface. This takes place preferentially if the elastomers and resins are highly nonpolar; the solubility of the typically more polar antioxidants, therefore, in the adhesive is lower. The observed discolorations, however, occur demonstrably even in the case of adhesives which contain polar resins, e.g., rosin esters. Since oxygen is able to act preferentially at the edge of the adhesive strip, it is also here that the first visible discoloration appears, and may become visible after just a few days to several weeks.

Discolorations occur to an increased extent when the adhesive strips are used on very rough substrates, for example, on woodchip wallpaper painted with acrylic emulsion paint. As a result of the coarse unevennesses of the wallpaper surface and the incomplete bond which results, atmospheric oxygen is able to pass into the unbonded interstices between adhesive strip and substrate, so that discolorations emerge with particular distinctness.

The easiest way to suppress the red discoloration is to forego the use of antioxidants, particularly the above-described sterically hindered phenols, and especially sterically hindered phenols which contain a 3-(p-hydroxyphenyl)propionic acid group or a 3-(o-hydroxyphenyl)propionic acid group. Since, however, such antioxidants are used as standard in a large number of base materials on the part of the manufacturers, foregoing them is normally not possible in practice.

A possibility for suppressing the red discoloration of sensitive substrates is provided surprisingly by the use of acidic compounds. The most obvious way of obtaining an acidic environment in an adhesive based on styrene block copolymers is to use acidic resins. The most suitable are rosin derivatives with only partially esterification if any. On the other hand, the use of rosin derivatives in hydrogenated elastomer systems, styrene-ethylene/butylene-styrene (obtainable by hydrogenation from styrene-butadiene-styrene block copolymers) or styrene-ethylene/propylene-styrene block copolymers (obtained by hydrogenation from styrene-isoprene-styrene block copolymers) is frequently impractical. These hydrogenated systems are used in order to obtain particular properties, either high transparency and colorlessness or stability toward UV light and ozone. Only very few rosin derivatives are colorless, so that they cannot be used when such an objective has been set. On the other hand, compatibility between the hydrogenated elastomers and the rosin derivatives is not especially high.

Furthermore, when rosin esters with a considerable residual free acid content are used, no substantial reduction in the red discoloration has been found. The red discoloration likewise set in after two to three weeks, as was observed when using terpene resins which contain no free acid groups.

Another way of introducing acidic substances into the adhesive is to use carboxylic acids, such as p-toluenesulfonic acid or stearic acid, and/or carboxylic anhydrides. Since these cannot be dissolved very well in the adhesive, especially in a nonpolar environment, the carboxylic acids and/or anhydrides migrate to the surface. The migration of ingredients to the surface of the adhesive strips, however, is undesirable, since it generally entails a loss of initial tack and bond performance.

It is also possible to incorporate polymers containing acid groups or anhydride groups, in order to suppress the red discoloration. Polyacrylic acid has a large number of acid groups, but owing to its high polarity it is very limited in its compatibility with the adhesives based on styrene block copolymers.

Polyolefins containing a high maleic anhydride fraction may likewise suppress red discoloration if they are soluble in the adhesive.

The problem with all additives to an adhesive is that they are not always completely compatible and may migrate to the surface. Furthermore, all of these additives greatly influence the mechanical properties and the bond performance.

For the very functioning of the stripping effect, the adhesives must possess particular mechanical properties.

The ratio of tensile strength to peel strength should be greater than two, preferably greater than three.

The ratio between peel strength and tensile strength is greatly influenced by the thickness of the adhesive strips. The peel strength required for detachment is composed of the force needed to detach the adhesive tape from the bond substrates and the force which must be exerted in order to deform the adhesive tape. The latter is approximately proportional to the thickness of the adhesive tape; the former may be assumed for simplification to be constant within the range of thicknesses in question. The tensile strength, on the other hand, rises in proportion to the tape thickness. It follows from this that, for self-adhesive tapes corresponding to DE 33 31 016 C2, the tensile strength below a certain thickness becomes smaller than the peel strength, and so correspondingly thin products are no longer partable from the substrates by stretching in the bond plane, and instead tear when such an attempt is made.

The peel strength per adhesive strip should not be greater than 30 N, since otherwise the force is too great, particularly for children. The peel strength is heavily dependent on the glass transition temperature of the overall system. Where the use temperature (room temperature) is very close to the glass transition temperature, the peel strengths increase massively. This may lead to the adhesive strips becoming very hard and tack-free. The service temperature should be at least 5° C., more preferably 10°C., above the glass transition temperature.

In order to avoid complications by an alteration in the properties when an acid-containing additive is added, the polymer incorporated should be highly compatible with the other components of the adhesive while still containing acid and/or acid anhydride groups.

Particularly suitable for this purpose are elastomers based on styrene-ethylene/butylene-styrene or styrene-ethylene/propylene-styrene which have been modified with acids and/or acid anhydrides. Elastomers of this kind are available commercially, for example, under the name Kraton FG 1901, Kraton FG 1921 and Kraton FG 1924 from Shell, or Tuftec M 1943, Tuftec M 1911, Tuftec M 1913, Tuftec 1962 from Asahi, based on styrene-ethylene/butylene-styrene, or Septon KL 01M1, Septon KL 02M2 from Kuraray, based on styrene-ethylene/propylene-styrene.

These elastomers with acid or anhydride functionalization have between 1 and 2% of acid groups, based on the overall weight of the elastomer. Frequently, maleic anhydride is the functionalization incorporated.

The above-described elastomers with acid or anhydride functionalization possess elastomeric analogs with an identical structure, without acid and/or acid anhydride groups, but with the same block polystyrene content and diblock content.

Through the use of these acid-modified elastomers it is possible to suppress red discoloration of the substrate almost completely, and in any case to retard it greatly.

The mechanical properties of the acid-modified or anhydride-modified elastomers are exactly the same as their unmodified analogs. The adhesive properties of the finished adhesive strips of modified elastomers are also very similar to those with elastomers without acid modification. The peel strengths or stripping forces are very slightly increased, but the tensile strengths are the same. The bond performance of the adhesive strips, which is likewise very similar between modified and unmodified elastomers, is determined by means of a peel test and by means of a wall hook test.

The acid-modified elastomers offer a further advantage: as a result of their greater polarity as compared with the unmodified elastomers, they are better able to solvate the resins and aging inhibitors, so that the aging inhibitors are unable to migrate so rapidly to the surface where they can react with the atmospheric oxygen.

### TEST METHODS

### Determination of the Discoloration Tendency

The adhesive sheet strips (dimensions: 20 mm×50 mm) are fastened to a chipboard panel on which coated woodchip wallpaper has been stuck (wallpaper=Erfurt Körnung 52, coated with the paint Herbol Zenit LG). The reverse face of the adhesive strips is not covered. The panels with the bonded adhesive strips are then stored in the dark in a forced air drying oven at 40° C. At weekly intervals, one adhesive strip is detached by pulling in the direction of the bond plane, and the wallpaper is then examined for discolorations.

### Tensile Strength//Maximum Elongation

Measurements are carried out, unless noted otherwise, in accordance with DIN 53504 using dumbbell specimens of size S3 and with a separation speed of 300 mm/min.

### Detachment Force (Stripping Force; Stripping Stress)

To determine the detachment force (stripping force), an adhesive sheet measuring 50 mm*20 mm (length*width), with a nonadhesive grip tab region at the top end, is bonded between two steel plates (arranged congruently with one another) measuring 50 mm×30 mm, in accordance with the procedure described under “tip shear strength (tip shear stability)”, but with an applied pressure of 500 N in each case. At the bottom end of each steel plate there is a drill hole to accommodate an S-shaped steel hook. The bottom end of the steel hook bears a further steel plate by means of which the test set up can be fixed in the lower clamping jaw of a tensile testing machine for the purpose of measurement. The bonds are stored at +40° C. for 24 h. After reconditioning to the RT, the adhesive sheet strip is removed with a pulling speed of 1000 mm/min, parallel to the bond plane and without contact with the edge regions of the two steel plates. During this procedure, the required detachment force is measured in N. The value reported is the mean value of the detachment stress (in N/mm²) in the region in which the adhesive strip has undergone between 10 mm and 40 mm detachment from the steel substrates.

### Peel Strength

To determine the peel strength, the PSA strip samples for investigation are laminated over the entire area of one side with a 23 μm PETP film (Hostaphan RN 25; Mitsubishi Chemicals), without air bubbles, after which the second adhesive sheet strip side is covered at one end with a film strip (likewise Hostaphan RN 25) about 6 mm long, thereby forming at this end a nonadhesive grip tab region on both sides. Thereafter, the test adhesive sheet strip is bonded by its front side, using gentle finger pressure, to the test substrate (coated woodchip wallpaper: wallpaper=Erfurt Körnung 52, paint=Herbol Zenit LG, wallpaper bonded to compressed chipboard). Samples are then pressed for 10 s at an applied pressure of 90 N per 10 cm² of bond area, then conditioned at 40° C. for 15 minutes. The test panels are then fixed horizontally so that the grippable region of the adhesive strips is pointing downward. Using a clamp (20 g), a 50 g weight is fastened to the nonadhesive grip tab, so that the resulting peel load (about 0.7 N per 20 mm of adhesive strip width) acts orthogonally to the bond plane. After 15 minutes and after 24 h, a mark is made of the distance over which the adhesive strip has peeled away from the bond substrate as from the beginning of the test. The distance between the two marks is reported as the peel path (units: mm per 24 h).

### Tip Shear Strength Tip Shear Stability

In order to determine the tip shear strength, the test adhesive sheet, which measures 20 mm×50 mm and is provided at one end on both sides with a nonadhesive grip tab region (obtained by laminating on 25 μm biaxially oriented polyester film measuring 20 mm×13 mm (Hostaphan RN 25)), is bonded to the center of a highly polished square steel plate measuring 40 mm×40 mm×3 mm (length×width×thickness). On its back, the steel plate is provided centrally with a 10 cm steel rod which sits vertically on the surface of the plate. The resulting test specimens are bonded to the test substrate with a force of 100 N (press-on time=5 sec) and are left in the unloaded state for 5 minutes. After the chosen tip shear load has been applied by suspending a weight (10 N with 50 mm lever arm), a measurement is made of the time which elapses until the bond fails (i.e., tip shear stability).

### PREPARATION OF THE TEST SPECIMENS

### Preparation of the Adhesive Strips

PSAs are processed to a homogeneous mixture in a heatable kneading apparatus with Sigma blades (Werner & Pfleiderer LUK 1.0 K3, fitted with an LTH 303 thermostat from mgw LAUDA) at a temperature of about +160 to +180° C., the mixture being rendered inert with CO₂ as protective gas. After the adhesive has cooled, it is made into single-layer adhesive sheet sections with a thickness of 700 μm±50 μm (mean ±2-fold standard deviation) by compressing it for about ten minutes at +120° C. to +140° C. (heatable press: model KHL 50 from Bucher-Guyer). Single-layer PSA strips with the desired dimensions are obtained by punching. While producing multi-layer PSA strips, the corresponding layers are obtained beforehand by lamination (by hot lamination where appropriate) and then the adhesive strips are individualized by punching.

### EXAMPLES

| | | |
|---|---|---|
| Example 1 | Vector 4211 (SIS) | 25% |
| | Vector 8508 (SBS) | 25% |
| | Foralyn 110 (rosin ester) | 50% |
| Example 2 | Vector 4113 (515) | 25% |
| | Vector 2518 (SBS) | 25% |
| | Foralyn 110 (rosin ester) | 50% |
| Example 3 | Kraton G 1650 (SEBS) | 20% |
| | Kraton G 1657 (SEBS) | 30% |
| | Escorez 5600 (hydr. HC resin) | 50% |
| Example 4 | Kraton G 1650 (SEBS) | 20% |
| | Kraton FG 1924X (SEBS**) | 30% |
| | Escorez 5600 (hydr. HC resin) | 50% |
| Example 5 | Kraton GRP 6919 (SEBS*) | 35% |
| | Kraton G 1657 (SEBS) | 15% |
| | Escorez 5600 (hydr. HC resin) | 50% |
| Example 6 | Kraton GRP 6919 (SEBS*) | 35% |
| | Kraton FG 1924X (SEBS**) | 15% |
| | Escorez 5600 (hydr. HC resin) | 50% |
| Example 7 | Kraton GRP 6919 (SEBS*) | 30% |
| | Kraton EG 1901X (SEBS**) | 10% |
| | Kraton G 1657 (SEBS) | 10% |
| | Escorez 5600 (hydr. HC resin) | 50% |
| Example 8 | Kraton GRP 6919 (SEBS*) | 30% |
| | Septon KL 03-M3 (SEPS**) | 10% |
| | Kraton G 1657 (SEBS) | 10% |
| | Escorez 5600 (hydr. HC resin) | 50% |
| Example 9 | Kraton GRP 6919 (SEBS*) | 30% |
| | Kraton G 1650 (SEBS) | 10% |
| | Kraton FG 1924X (SEBS**) | 10% |
| | Escorez 5600 (hydr. HC resin) | 50% |

*contains polyisoprene side chains
**modified with maleic anhydride (2%)

### Discoloration Tendency

| | Discoloration tendency |
|---|---|
| | Discoloration clearly visible |
| Example | after. . .weeks |
| Example 1 | 3 |
| Example 2 | 2 |
| Example 3 | 1 |
| Example 4 | 8 |
| Example 5 | 1 |
| Example 6 | 9 |
| Example 7 | 8 |
| Example 8 | 7 |
| Example 9 | 7 |

### Mechanical and Adhesive Data

| | | Detachment | | Tip shear |
|---|---|---|---|---|
| | Tensile strength | stress | Peel rate | stability |
| Example No. | in MPa | in N/mm² | in mm/24 h | in days |
| 3 | 9.2 | 2.1 | 14* | >100 |
| 4 | 9.5 | 2.2 | 16* | >100 |
| 5 | 9.1 | 1.6 | 17 | >100 |
| 6 | 8.2 | 1.7 | 15 | >100 |

*Under a load of 20 g

What is claimed is:

1. An adhesive sheet strip for a bond which is redetachable without residue or destruction by extensive stretching in the bond plane, having a pressure sensitive adhesive based on styrene block copolymers, wherein the pressure sensitive adhesive comprises an acid-modified and/or acid anhydride-modified elastomer.

2. The adhesive sheet strip as claimed in claim 1, wherein the elastomer is based on SEBS and/or SEPS.

3. The adhesive sheet strip as claimed in claim 1, wherein the elastomer accounts for from 30 to 60% by weight, in particular from 35 to 55% by weight, of the pressure sensitive adhesive.

4. The adhesive sheet strip as claimed in claim 1, wherein the elastomer contains from 1 to 2% of acid groups, based on the overall weight of the elastomer, in particular in the form of incorporated maleic anhydride.

5. The adhesive sheet strip as claimed in claim 1, wherein the pressure sensitive adhesive comprises tackifiers and, where appropriate, further additives, plasticizing agents and/or fillers.

6. The adhesive sheet strip as claimed in claim 1, provided on one side or in particular on both sides with the pressure sensitive adhesive.

7. The adhesive sheet strip as claimed in claim 1, comprising a nonadhesive grip tab.

8. The adhesive sheet strip as claimed in claim 1, comprising only the pressure sensitive adhesive (where appropriate with grip tab) or being a laminate, in particular a laminate having a stretchable backing.

9. A process for producing an adhesive sheet strip as claimed in claims 1-8, which comprises using a pressure sensitive adhesive as set forth in any of claims 1-8, where appropriate on a stretchable backing.
